(19) United States
(12) Patent Application Publication
(10) Pub. No.: US 2025/0338255 A1
(43) Pub. Date: Oct. 30, 2025

(54) TECHNIQUES FOR COMMUNICATING POSITIONING RELATED REFERENCE SIGNALS FOR WIRELESS DEVICES

(71) Applicant: ZTE CORPORATION, Shenzhen (CN)

(72) Inventors: Chuangxin Jiang, Shenzhen (CN); Focai Peng, Shenzhen (CN); Yu Pan, Shenzhen (CN); Cong Wang, Shenzhen (CN); Di Zong, Shenzhen (CN); Xuan Ma, Shenzhen (CN)

(73) Assignee: ZTE CORPORATION, Shenzhen (CN)

(21) Appl. No.: 18/995,747

(22) PCT Filed: Sep. 23, 2022
(86) PCT No.: PCT/CN2022/121014

§ 371 Date: Jan. 16, 2025

(51) Int. Cl. H04W 68/02; H04W 64/00; H04W 76/27

(52) U.S. Cl. CPC H04W 68/025; H04W 64/00; H04W 76/27

(57) ABSTRACT

Techniques are described to receive a positioning related reference signal that is associated with paging indication. An example wireless communication method includes determining, by a wireless device, a paging indication; and performing a positioning related operation in response to the determining the paging indication, wherein the positioning related operation is associated with the paging indication.

### CROSS-REFERENCE TO RELATED APPLICATION

This application is a continuation of International Application No. PCT/CN2022/121014 filed on Sep. 23, 2022, which is hereby incorporated by reference in its entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for receiving a positioning related reference signal (e.g., positioning reference signal (PRS) or sounding reference signal (SRS)) that is associated with a paging reception (or paging indication).

An example wireless communication method includes determining, by a wireless device, a paging indication; and performing a positioning related operation in response to the determining the paging indication, where the positioning related operation is associated with the paging indication.

In some embodiments, an association between the positioning related operation and the paging indication is included in a system information block (SIB) or a radio resource control (RRC) release signaling received by the communication device. In some embodiments, the positioning related operation is performed by the wireless device in an inactive state or an idle state, and the positioning related operation includes receiving or transmitting a reference signal, transmitting a measurement report, receiving a first shared channel, or transmitting a second shared channel. In some embodiments, the receiving or transmitting the reference signal includes receiving a positioning reference signal or transmitting a sounding reference signal.

In some embodiments, the method further comprises receiving, by the wireless device, the paging indication in a periodic paging time window (PTW), where the wireless device performs the positioning related operation in the PTW in response to receiving the paging indication. In some embodiments, the method further comprises receiving, by the wireless device, a paging early indication (PEI) that indicates that the wireless device is expected to receive the paging indication, where the wireless device performs the positioning related operation in response to the receiving the paging indication and the PEI. In some embodiments, the wireless device receives a system information block (SIB) or a radio resource control (RRC) release signaling that indicate: (1) whether the PEI indicates that the wireless device is expected to receive the paging indication, or (2) whether one or more time windows for performing the positioning related operation is associated with the paging indication that is indicated by the PEI.

In some embodiments, the method further comprises receiving, by the wireless device, a paging early indication (PEI) that indicates that the wireless device is expected to receive the paging indication, where the wireless device performs the positioning related operation in response to the receiving the paging indication and the PEI and response to one or more conditions between the one or more time windows for performing the positioning related operation and the paging indication being satisfied. In some embodiments, the one or more conditions is satisfied when the paging indication is received overlapping with a time window in time domain. In some embodiments, the one or more conditions is satisfied in response to a distance in time domain between the paging indication and a time window being less than a threshold. In some embodiments, the method further comprises receiving, by the wireless device, a paging early indication (PEI) that indicates that the wireless device is expected to receive the paging indication, where the paging indication indicates that a time window is valid, and where the wireless device receives a positioning reference signal in response to the receiving the paging indication and the PEI.

In some embodiments, the method further comprises receiving, by the communication device, a paging early indication (PEI) that indicates whether the communication device is expected to receive a synchronization signal block (SSB) and a positioning reference signal. In some embodiments, the wireless device determines not to detect or receive or monitor the SSB and/or the positioning reference signal in response to an absence of reception of the paging indication. In some embodiments, the method further comprises receiving, by the wireless device, a control information or a paging related signaling that indicates to the communication to enter a sleep mode after: a paging occasion, receiving a positioning reference signal, the paging occasion and the receiving the positioning reference signal, a time duration after the paging occasion and the receiving the positioning reference signal, a time duration after a reception of a paging early indication (PEI), or transmission of a measurement report or a small data transmission.

In some embodiments, the paging indication is associated with one paging reception window, one periodic paging time window (PTW), one paging occasion (PO), one paging frame (PF), one or more PO sub-groups, one or more PF sub-groups, one paging monitoring occasion (PMO), or one or more PMO sub-groups, where at least one of the one or more PO sub-groups includes one or more POs, at least one of the one or more PF sub-groups includes one or more PFs, or at least one of the one or more PMO sub-groups includes one or more PMOs. In some embodiments, the wireless device includes a base station, and where the method further comprises: receiving, by the base station, a reference signal received power (RSRP) related information from a location management function (LMF) that includes any one or more of the following: a RSRP value, a positioning reference signal PRS) resource and/or resource set configuration that includes a PRS time configuration or PRS frequency configuration, and/or a center frequency, a time stamp, a reference signal time difference (RSTD) or a UE receive-transmit timing value, a physical cell identifier, a cell global identifier, a downlink physical reference signal resource identifier.

In some embodiments, the RSRP related information is reported by a communication device to the LMF. In some embodiments, the wireless device includes a communication device, where the determining the paging indication includes receiving the paging indication, and where the performing the positioning related operation includes receiving a positioning reference signal. In some embodiments, the wireless device includes a base station, where the determining the paging indication includes transmitting the paging indication, and where the performing the positioning related operation includes receiving a sounding reference signal.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1A shows example technique for performing a paging reception in radio resource control (RRC) inactive or idle state.

FIG. 1B shows example technique for performing multiple signals reception in RRC inactive or idle state.

FIG. 1C shows an example association between two positioning reference signal (PRS) reception window and paging occasions (POs).

FIG. 2A shows an example paging early indication (PEI) for paging indication.

FIG. 2B shows PEI for paging indication and PRS reception.

FIG. 2C shows UE for only monitoring or receiving PRS within PTW.

FIG. 3 shows an example technique where PEI indicates synchronization signal block (SSB) reception.

FIG. 4 shows an example technique where PEI indicates ultra-deep sleep mode.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIG. 7 shows an exemplary flowchart for performing a positioning related operation.

### DETAILED DESCRIPTION

For a type of user equipment (UE) that may need very low power consumption and high positioning accuracy, UE may stay in radio resource control (RRC) inactive state or RRC idle state to preserve battery life. When some traffic services come to the UE, e.g., location service request is triggered by UE itself or by network, UE can wake up from inactive or idle state and process the signaling. In such a case, more power is consumed. In order to reduce UE power consumption, it is desirable to let UE wake up as fewer times as possible. However, the details are still unclear how to design the control signaling to achieve power reduction for positioning.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

Currently, positioning service is common among users no matter in outdoor or indoor. In outdoor scenarios, global positioning system (GPS) can be used for positioning. In indoor scenarios, GPS signal power may be too weak to get accurate positioning estimation. In such scenarios, wireless dependent positioning solutions can be used, such as timing difference based positioning solution. Based the wireless dependent positioning methods, transmit-receive points (TRPs) or UEs can transmit positioning reference signal (RS) (e.g., positioning reference signal (PRS) or sounding reference signal (SRS)), then the receiver side (e.g., UEs or TRPs) can measure the positioning reference signal to get the positioning related measurement results. However, power consumption is needed to receive or transmit positioning RS. This can significantly reduce UE battery life especially for some low cost UEs.

Table 1 shows use cases and requirements for low power high accuracy positioning (LPHAP).

TABLE 1
Low power high accuracy positioning use cases

| Use | | | Corresponding | Positioning | | | |
|---|---|---|---|---|---|---|---|
| Case | Horizontal | | service level | interval/ | | Battery life time/minimum | |
| # | accuracy | | (22.261) | duty cycle | | operation time | |
| 1 | 10 | m | Service Level 1 | on request | | 24 | months |
| 2 | 2 m to 3 m | | Service Level 2 | <4 | seconds | >6 | months |
| 3 | <1 | m | Service Level 3 | no indication | | 1 work shift - 8 hours | |
| | | | | | | (up to 3 days, 1 month | |
| | | | | | | for inventory purposes) | |
| 4 | <1 | m | Service Level 3 | 1 | second | 6-8 | years |
| 5 | <1 | m | Service Level 3 | 5 seconds-15 | | 18 | months |
| | | | | minutes | | | |
| 6 | <1 | m | Service Level 3 | 15 s to 30 s | | 6-12 | months |
| 7 | 30 | cm | Service Level 5 | 250 | ms | 18 | months |

| | | | | | | |
|---|---|---|---|---|---|---|
| 8 | 30 | cm | Service Level 5 | 1 | second | 6-8 years (no strong |
| | | | | | | limitation in battery size) |
| 9 | 10 | m | Service Level 1 | 20 | minutes | 12 years (@20 mJ/position fix) |

As shown in Table 1, different use cases can have different requirements of accuracy, interval and power consumption. However, these use cases can need a long battery life for LPHAP UEs. For those LPHAP UEs, one of the motivations is for positioning purpose. They can receive system information such as synchronization signal block (SSB), system information block (SIB) and paging information to camp on a cell as regular UEs.

### II. Example Embodiment #1

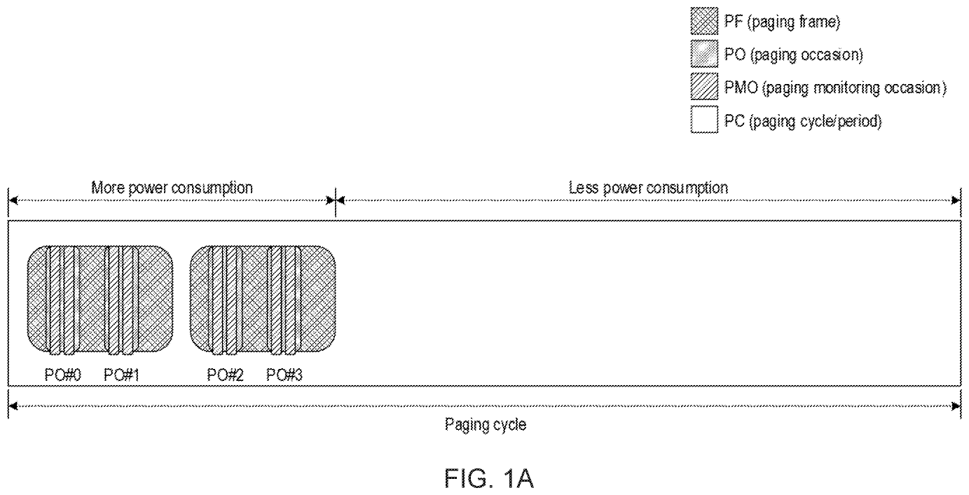

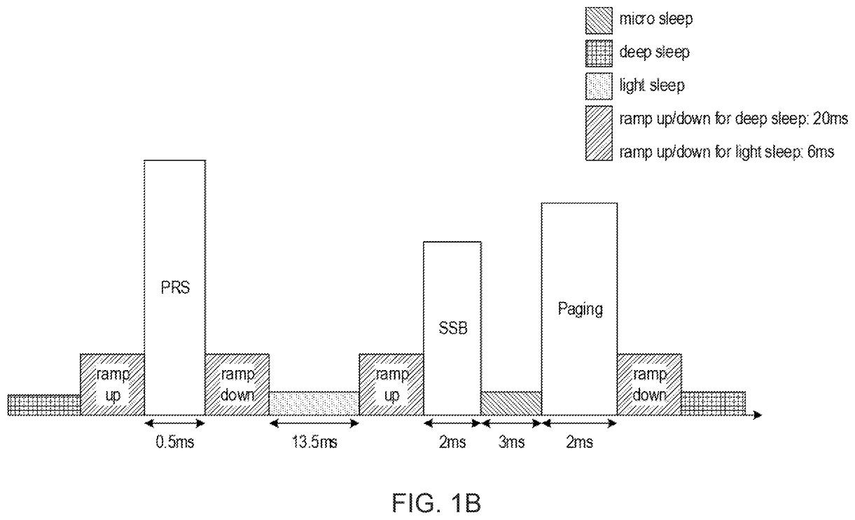

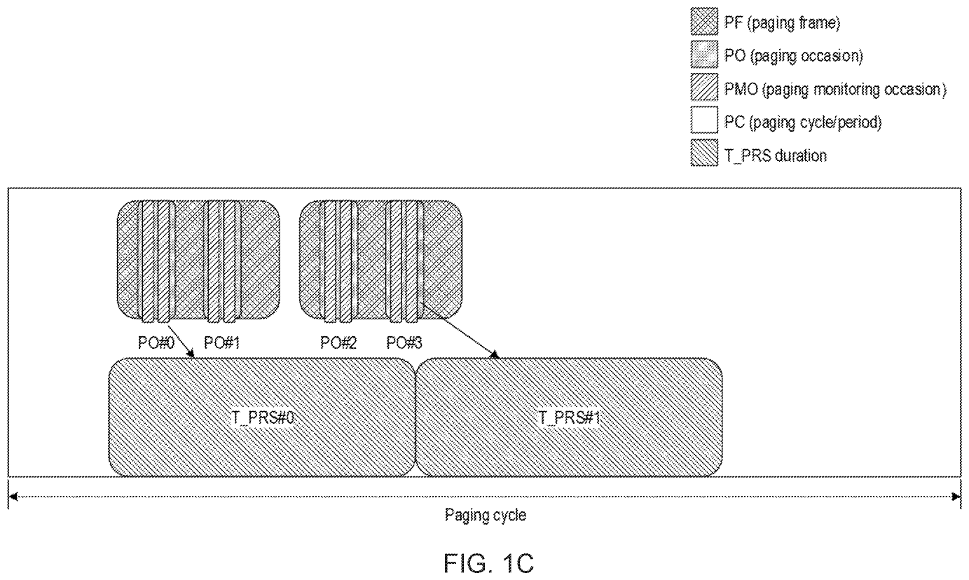

FIG. 1A shows example technique for performing a paging reception in RRC inactive or idle state. For LPHAP UEs, to achieve extremely low power consumption, UE can be expected to keep in (or stay in) RRC inactive or RRC idle state even when receiving paging or SSB signaling as shown in the FIG. 1A. In other words, UE does not need to transit from RRC inactive/idle state to RRC connected state for power saving. However, UE may still transit from sleep mode to active mode in order to receive paging information as shown in FIG. 1A, where more power consumption is needed to detect or receive or monitoring paging information. This patent document refers to paging reception as paging indication.

The UE may use Discontinuous Reception (DRX) in RRC_IDLE and RRC_INACTIVE state in order to reduce power consumption. The UE monitors one paging occasion (PO) per DRX cycle. A PO is a set of PDCCH monitoring occasions and can consist of multiple time slots (e.g. subframe or OFDM symbol) where paging DCI can be sent. One Paging Frame (PF) is one Radio Frame and may contain one or multiple PO(s) or starting point of a PO.

Thus, when UE doesn't detect paging signaling in a long duration, UE can fall into a very sleep mode to achieve less power consumption.

Furthermore, if the interval between two paging signaling or some other signaling are not long enough, UE maybe only fall into a micro sleep or light sleep between the two signals reception/transmission. As shown in Table 2, Table 3 and FIG. 1B as examples, the power consumption in deep sleep mode, light sleep mode and micro sleep mode is increasing significantly as shown in Table 3. However, the necessary transition time and additional transition energy/power is also increasing significantly. That is, although UE energy consumption is lowest in deep sleep mode, UE need a very long time to transition from active mode to fall into deep sleep mode, and much extra energy will be consumed duration the transition duration. In other words, if the interval between two signaling processing is not long enough, UE may only fall into light sleep mode or micro sleep mode. In short, the larger interval, the deeper sleep UE can be going to.

TABLE 2
UE power consumption during the state transition

| | Additional transition | |
|---|---|---|
| | energy: (Relative | Total transition |
| Sleep type | power × ms) | time |
| Deep sleep | 450 | 20 ms |
| Light sleep | 100 | 6 ms |
| Micro sleep | 0 | 0 ms |

TABLE 3
UE power consumption in different sleep modes

| Power | | |
|---|---|---|
| State | Characteristics | Relative Power |
| Deep | Time interval for the sleep can be larger than | 1 (Optional: 0.5) |
| Sleep | the total transition time entering and | |
| | leaving this state. | |
| | Accurate timing may not be maintained. | |
| Light | Time interval for the sleep can be larger than | 20 |
| Sleep | the total transition time entering and | |
| | leaving this state. | |
| Micro | Immediate transition is assumed for power | 45 |
| sleep | saving study purpose from or to a non-sleep | |
| | state | |

FIG. 1B shows example technique for performing multiple signals reception in RRC inactive or idle state. As shown in FIG. 1B, the interval between PRS and SSB is larger than 6 ms and smaller than 20 ms, then UE is going to light sleep mode. The interval between SSB and paging is smaller than 6 ms, then UE is going to micro sleep mode.

Thus, to achieve more power consumption gain, the number of transition times can be reduced, especially the transition from deep sleep mode to active mode as it costs most extra power consumption.

One example method is to set up the association between each paging reception and each PRS reception window. Each paging reception can be associated with one paging reception window, one PO, one PF, one or more PO sub-groups, one or more PF sub-groups, one or more paging monitoring occasions (PMOs), or one or more PMO sub-groups, where one paging reception window is a time duration, and where at least one of the one or more PO sub-groups includes one or more POs, at least one of the one or more PF sub-groups includes one or more PFs, or at least one of the one or more PMO sub-groups includes one or more PMOs. Specifically, UE may detect the PRS in the PRS reception window if UE detects the associated paging reception. In other words, if UE doesn't detect paging information in some paging reception, UE may not or is not mandated to detect PRS in the associated PRS reception window.

FIG. 1C shows an example association between two PRS reception window and POs. As shown in FIG. 1C, the association between the two PRS reception window and paging receptions is configured by SIB, or RRC_Release signaling. For example, PO #0 and PO #3 are associated with PRS window #0 and #1 respectively. If UE detects PO #0, then UE also detects the PRS in PRS reception window #0, otherwise UE doesn't need to detect PRS in PRS reception window #0. If UE detects PO #3, then UE also detects the PRS in PRS reception window #1, otherwise UE doesn't need to detect PRS in PRS reception window#1. Whether UE detects PRS is not relied on PO #1 and PO #2.

### III. Example Embodiment #2

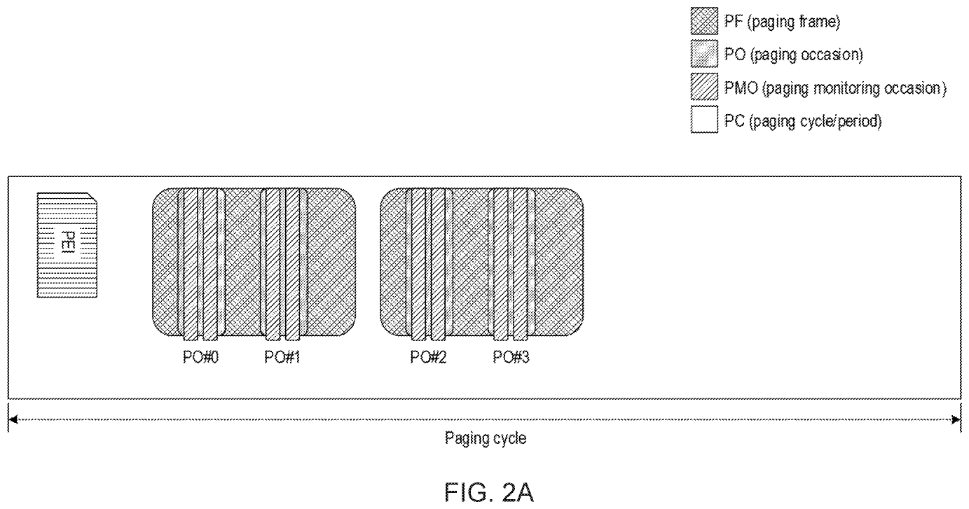

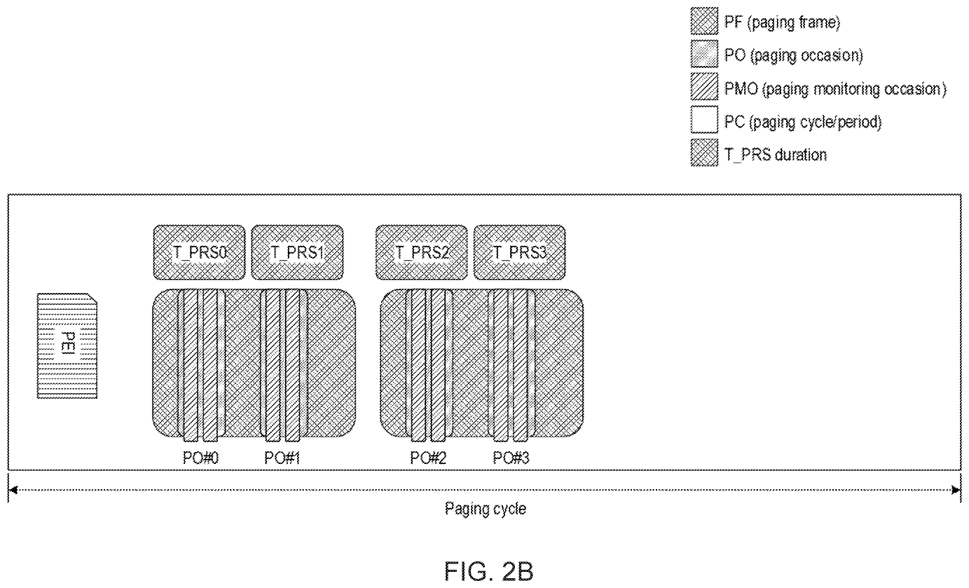

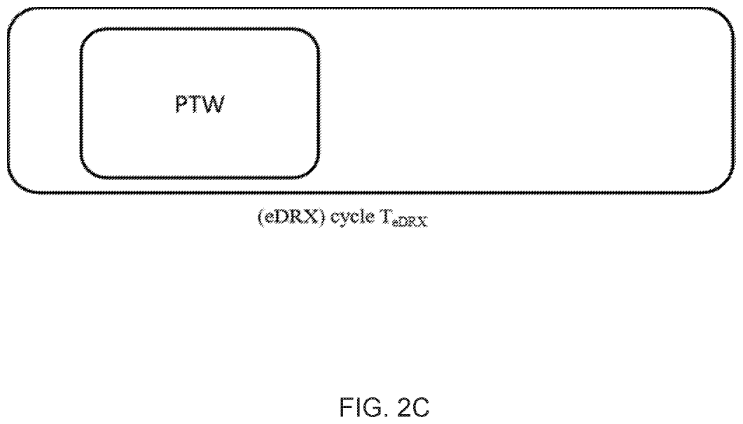

FIG. 2A shows an example paging early indication (PEI) for paging indication. As shown in FIG. 2A, PEI is used to indicate whether the subsequent paging subgroups can be detected by UE or not. That is, PEI carried by DCI can be used to let UE only detects or monitor none of or some of paging subgroups in one DRX cycle to save power. If PEI is not transmitted, all corresponding paging subgroups will not be detected by UE.

One method to further reduce power consumption for PRS reception is to reuse the existing PEI without adding any bits in DCI 2_7. Specifically, set up the association between each paging reception and each PRS reception window. If the PEI indicates to the UE to receive the paging reception, then UE may detect PRS in the associated PRS reception window. Each paging reception can be associated with one paging reception window, one PO, one PF, one or more PO sub-groups, one or more PF sub-groups, one or more paging monitoring occasions (PMOs), or one or more PMO sub-groups, where one paging reception window is a time duration, and where at least one of the one or more PO sub-groups includes one or more POs, at least one of the one or more PF sub-groups includes one or more PFs, or at least one of the one or more PMO sub-groups includes one or more PMOs. The procedure is
UE may report that it supports this new feature.
SIB or RRC_Release signaling is to indicate to UE whether PEI also indicates PRS reception or whether PRS reception window is associated with paging reception indicated by PEI.
If so, if the PEI indicates to the UE to receive the paging reception, then UE may detect PRS in the associated PRS reception window.
   FIG. 2B shows PEI for paging indication and PRS reception. For examples as shown in FIG. 2B, PO #0, #1, #2 and #3 are associated with PRS window #0, #1, #2 and #3 respectively. If PEI indicates that UE may detect some paging monitoring occasions of PO #1, UE may also detect PRS in PRS window #1 and UE may not necessarily detects PRS in other PRS windows.
   PEI can also be used to indicate the real number of PRS reception windows. The indicated real number can be equal to or smaller than the number of higher layer configured PRS reception windows.
      For example, two PRS reception windows are configured by RRC signaling or LPP signaling, PEI is used to select 0 or 1 or 2 windows. If only 1 is selected, it may be up to UE to determine which one is finally used for actual PRS reception.

One of the benefits of this method is that UE can wake up and detects both paging and PRS. If UE doesn't need to wake up for paging reception, then UE is also not needed to wake up dedicatedly for PRS reception.

It is noted that some paging reception may not be associated with PRS window depending on the configuration or UE capability.

The PRS reception window indicated by T_PRS duration in FIG. 2B can be replaced by the window for SRS transmission, or measurement report. That is because, for UL-TDOA positioning method, SRS may be transmitted instead of DL PRS reception. The logical is the same, that is, UE only wake up once (not falling into deep sleep mode) to both transmit SRS and detect paging.

### IV.(a) Example Embodiment #3

Compared with Example Embodiment #2, another solution can be to simplify the association between paging reception and PRS reception window. Specifically, for a PRS reception window, if a paging reception is needed, e.g., indicated by PEI, and one or more conditions between PRS reception window and the paging reception are satisfied, then UE detects the PRS, otherwise, UE does not need to detect PRS. The one or more conditions being satisfied may include the following:
A paging reception overlaps with PRS reception window in time domain
The distance in time domain between a paging reception and a PRS reception window is smaller than a threshold
   The threshold can be preconfigured or up to UE capability or configured by SIB, RRC_Release signaling or some other signaling.
The paging reception is performed by UE

Another solution is to determine whether PRS reception window is valid or not is based on whether there is paging reception. That is, once PEI indicates at least one paging reception, the PRS reception window is valid, UE may detect PRS in the PRS reception window.

For a type of UE which may have very low power consumption and high positioning accuracy, UE states in RRC inactive state or RRC idle state in its most battery life. When some traffic services come, e.g. location service request is triggered by UE itself or by network, UE has to wake up from inactive or idle state and process the signaling. In such case, much more power consumption is needed. In order to reduce UE power consumption, it is desirable to let UE wake up as less times as possible. However, the details are still unclear how to design the control signaling to achieve power reduction for positioning.

One method is to set up the association between each paging reception and each PRS reception window. Each paging reception can be associated with one paging reception window, one PO, one PF, one or more PO sub-groups, one or more PF sub-groups, one or more paging monitoring occasions (PMOs), or one or more PMO sub-groups, where one paging reception window is a time duration, and where at least one of the one or more PO sub-groups includes one or more POs, at least one of the one or more PF sub-groups includes one or more PFs, or at least one of the one or more PMO sub-groups includes one or more PMOs. Specifically, UE may detect the PRS in the PRS reception window if UE detects the associated paging reception. In other words, if UE doesn't detect paging information in some paging reception, UE may not or is not mandated to detect PRS in the associated PRS reception window. The association between the two PRS reception window and paging receptions is configured by SIB, or RRC_Release signaling.

If the PEI indicates to the UE to receive the paging reception, then UE may detect PRS in the associated PRS reception window.

Alternatively, for a PRS reception window, if a paging reception is needed, e.g. indicated by PEI, and one or more conditions between PRS reception window and the paging reception are satisfied, then UE detects the PRS, otherwise, UE does not need to detect PRS.

### IV. (b) Embodiment #3-1

For simplicity, PEI is to indicate a UE whether to monitor or receive paging occasion(s) in one DRX cycle. The above solutions can be summarized such that, UE monitoring or receiving PRS in one DRX cycle depends on whether UE to monitor or receive paging occasion(s) which indicated by PEI.

To further reduce UE power consumption, another solution is to adopt extended DRX cycle which is longer. During the extended cycle, it is better to associate PRS reception and PO monitoring in the same window where the window is a periodic Paging Time Window (PTW) configured for the UE.

One example is, UE may only monitor or receive PRS within PTW during an extended DRX cycle. FIG. 2C shows that UE only monitor or receive PRS within PTW.

Another example is, whether UE receive PRS within a PTW during an extended DRX cycle depends on whether UE to monitor or receive paging occasion(s) within the PTW. For further power reducing, UE will not receive PRS and/or paging outside PTW in the extended DRX cycle.

Another example is, for a DCI, e.g. DCI 2_7 in an extended DRX cycle Ti is used to indicate whether UE to receive PRS or not in the subsequent DRX cycle Ti+1. Some bits in DCI2_7 can be used, e.g. the existing PEI or extra bit(s). The reason is because PRS transmission may be before the PTW.

### V. Embodiment #4

In addition to power consumption of PRS reception, SSB also cost much power consumption. Hence, another solution is to use PEI to indicate whether some SSB or all SSB can be detected by UE.

Because one paging occasion or monitoring occasion may correspond to one SSB, then the existing PEI bits which indicate the sub-group of paging occasions or monitoring occasions that is associated with one SSB. SSB will not be detected if the corresponding paging occasions or sub-group paging occasions are not detected based on PEI. In such case, no extra DCI bits is needed in the DCI format 2_7.

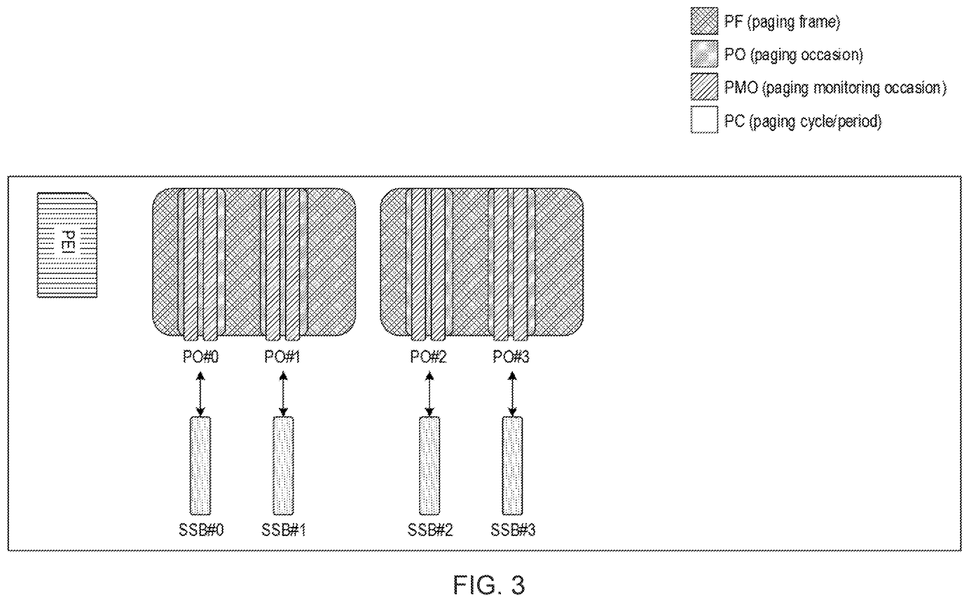

FIG. 3 shows an example technique where PEI indicates SSB reception. As shown in FIG. 3, one SSB corresponds to one paging occasion or one paging sub-group or one paging monitoring occasion. For example, if PEI indicates PO #2 and #3 are not detected, then SSB #2 and #3 may also not be needed to detect for power saving.

Specifically, if one paging occasion or one paging sub-group or one paging monitoring occasion is not detected based on PEI, the corresponding SSB may also not be detected, where the corresponding SSB is the QCL source of the paging channel, or have the same receive beam with paging channel.

Hence, combined with Example Embodiment #1, #2, #3 and #4, PEI can be used to indicate whether all of Paging, PRS and SSB reception is needed or not. That is, one PEI bit can be used to indicate a combination of paging occasion (paging occasion subgroup), PRS reception and SSB.

Thus, the solution is that, determine whether SSB is detected or not depends on whether paging is detected.

An alternative solution is to simplify the association between SSB reception (and/or PRS reception) and paging reception. Specifically, for a SSB reception or reception window which is SMTC, if a paging reception is needed, e.g. indicated by PEI, and one or more conditions between SSB reception (and/or PRS reception) and the paging reception are satisfied, then UE detects the SSB, otherwise, UE does not need to detect SSB
A paging reception overlaps with SSB reception window in time domain.
The distance in time domain between a paging reception and a SSB reception or reception window is smaller than a threshold
   The threshold can be preconfigured or up to UE capability or configured by SIB, RRC_Release signaling or some other signaling.
The paging reception is performed by UE.

Another solution is to determine whether SSB reception window is valid or not based on whether there is paging reception. That is, once PEI indicates at least one paging reception, the SSB reception or reception window is valid, UE needs to detect or receive or monitor SSB.

Another solution is, PEI can be used to indicate the number of SSB measurements, and/or the number PRS reception windows. For example, extra X bits in DCI 2_7 are used to indicate the number of SSB measurements, where X value may depend on the frequency range, DRX cycle length, etc.

Another solution is to determine whether both SSB and PRS reception is needed or

not based on whether there is paging reception. That is, once PEI indicates at least one paging reception, both SSB and PRS reception or reception window is valid, UE needs to detect or receive or monitor both SSB and PRS. Otherwise, UE will detect or receive or monitor neither of SSB and PRS.

### VI. (a) Example Embodiment #5

In some scenarios, UE implementation may be diverse and not easily controlled by network. For the sake of power saving, it is better to introduce a new ultra-deep sleep mode which needs very low power consumption if UE is going to such ultra-deep sleep mode.

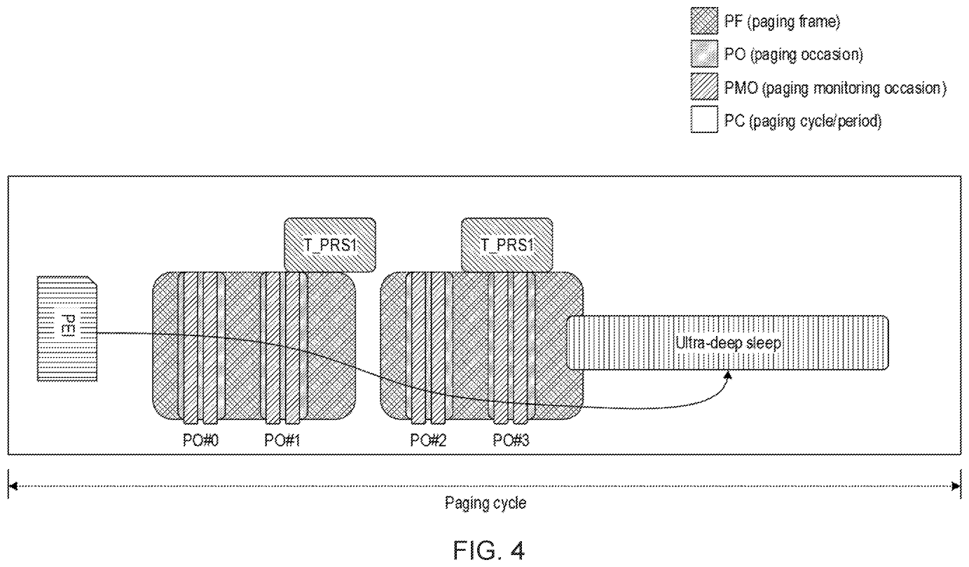

One solution is to use DCI 2_7 or paging related signaling to indicate UE going to an ultra-deep sleep mode.
One specific case is, DCI (e.g., with DCI 2_7 format) or paging related signaling indicates UE going to ultra-deep sleep mode after a paging occasion.
   The paging occasion can be the last paging occasion or monitoring occasion configured by higher layer signaling in the paging cycle, e.g. by SIB. FIG. 4 shows an example technique where PEI indicates ultra-deep sleep mode. As shown in FIG. 4, the last configured paging occasion is in PO #3.

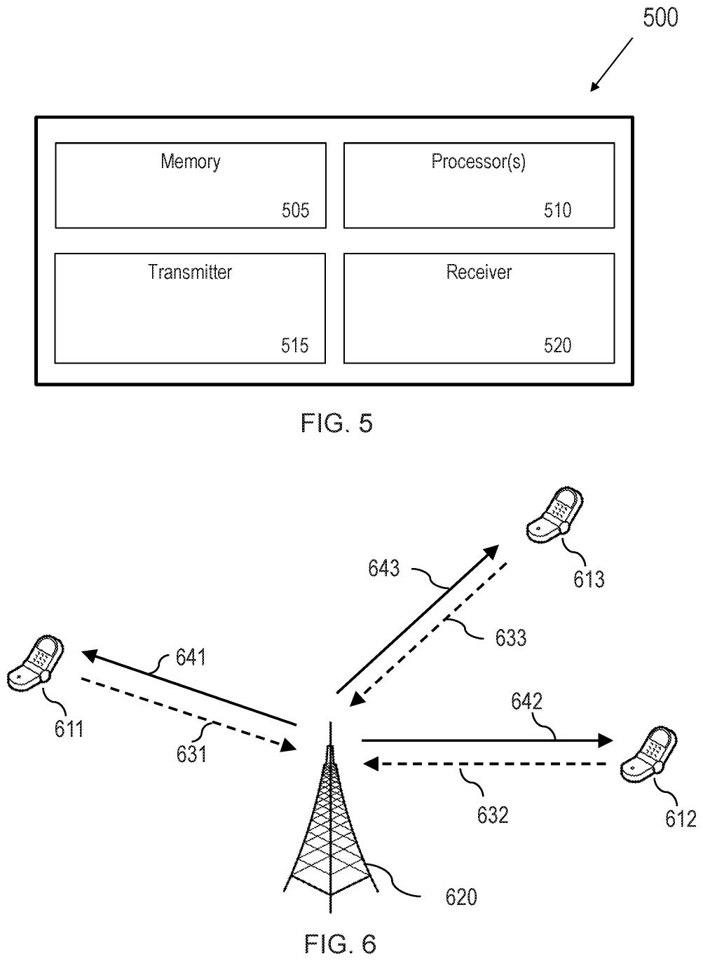

Alternatively, the paging occasion can be the last paging occasion or monitoring occasion which need to be detected and indicated by PEI. As shown in the FIG. 5-1, the last configured paging occasion is in PO #3.
Another specific case is, DCI (e.g., with DCI 2_7 format) or paging related signaling indicates UE going to ultra-deep sleep mode after PRS reception.
Another specific case is, DCI (e.g., with DCI 2_7 format) or paging related signaling indicates UE going to ultra-deep sleep mode after a paging occasion and PRS reception.
   PRS reception can be the last PRS reception window.
Another specific case is, DCI (e.g., with DCI 2_7 format) or paging related signaling indicates UE going to ultra-deep sleep mode X time duration after a paging occasion and/or PRS reception.
Another specific case is, DCI (e.g., with DCI 2_7 format) or paging related signaling indicates UE going to ultra-deep sleep mode X time duration after PEI.
   X can be predefined or higher layer configured or depends on UE capability. The unit of X can be ms, slots, or symbol.
Another specific case is, it indicates UE going to ultra-deep sleep mode after or X time duration after a positioning measurement report or a small data transmission in RRC inactive state.

The duration of the ultra-deep sleep mode can be predefined or configured by higher layer signaling, or can be up to UE implementation.

### VI. (b) Example Embodiment #5-1

Another solution is to use PEI or paging or SIB or RRC_Release configuration to indicate UE accessing in Ultra-deep sleep mode. And whether UE is actually accessing in Ultra-deep sleep mode still depends on some one or more following conditions:
T>T_thresh_0, where T is the time interval between two signals which UE may need to wake up to proceed, T_thresh_0 can be predefined or higher layer configured or up to UE capability.
PRS or SRS periodicity>T_thresh_1.
The DRX cycle>T_thresh_2.

### VII. Example Embodiment #6

Based on the previous solution, SSB can be disabled by PEI or SIB or RRC_Release configuration or Paging signaling for power saving. In such case, UE mobility may suffer some issue because no RSRP or RSRQ measurement based on SSB especially from some neighbor cells.

However, for positioning purpose, PRS can be measured by UE and the reported measurement results can be informed to LMF. Furthermore, since PRS bandwidth is larger than SSB, the PRS-RSRP measurement is more accurate than SSB.

Hence, one solution is that, LMF inform RSRP related information to serving gNB may include one or more of following
RSRP value
PRS resource and/or resource set configuration may include PRS time/frequency configuration, center frequency
Time stamp
nr-RSTD or UE Rx-Tx timing
nr-PhysCellID
nr-CellGlobalID.
nr-DL-PRS-ResourceID

Any one or more of Example Embodiments #1-#6 can be combined.

FIG. 5 shows an exemplary block diagram of a hardware platform 500 that may

be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1A to 4 and 6 to 7 in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

The implementations as discussed above will apply to a wireless communication.

FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

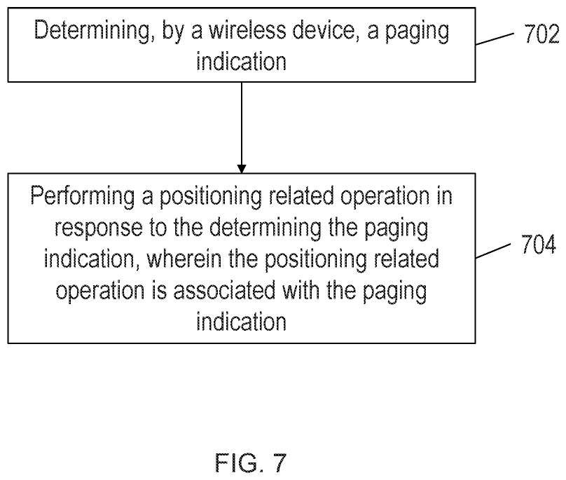

FIG. 7 shows an exemplary flowchart for performing a positioning related operation. Operation 702 includes determining, by a wireless device, a paging indication. Operation 704 includes performing a positioning related operation in response to the determining the paging indication, where the positioning related operation is associated with the paging indication.

In some embodiments, an association between the positioning related operation and the paging indication is included in a system information block (SIB) or a radio resource control (RRC) release signaling received by the communication device. In some embodiments, the positioning related operation is performed by the wireless device in an inactive state or an idle state, and the positioning related operation includes receiving or transmitting a reference signal, transmitting a measurement report, receiving a first shared channel, or transmitting a second shared channel. In some embodiments, the receiving or transmitting the reference signal includes receiving a positioning reference signal or transmitting a sounding reference signal.

In some embodiments, the method further comprises receiving, by the wireless device, the paging indication in a periodic paging time window (PTW), where the wireless device performs the positioning related operation in the PTW in response to receiving the paging indication. In some embodiments, the method further comprises receiving, by the wireless device, a paging early indication (PEI) that indicates that the wireless device is expected to receive the paging indication, where the wireless device performs the positioning related operation in response to the receiving the paging indication and the PEI. In some embodiments, the wireless device receives a system information block (SIB) or a radio resource control (RRC) release signaling that indicate: (1) whether the PEI indicates that the wireless device is expected to receive the paging indication, or (2) whether one or more time windows for performing the positioning related operation is associated with the paging indication that is indicated by the PEI.

In some embodiments, the method further comprises receiving, by the wireless device, a paging early indication (PEI) that indicates that the wireless device is expected to receive the paging indication, where the wireless device performs the positioning related operation in response to the receiving the paging indication and the PEI and response to one or more conditions between the one or more time windows for performing the positioning related operation and the paging indication being satisfied. In some embodiments, the one or more conditions is satisfied when the paging indication is received overlapping with a time window in time domain. In some embodiments, the one or more conditions is satisfied in response to a distance in time domain between the paging indication and a time window being less than a threshold. In some embodiments, the method further comprises receiving, by the wireless device, a paging early indication (PEI) that indicates that the wireless device is expected to receive the paging indication, where the paging indication indicates that a time window is valid, and where the wireless device receives a positioning reference signal in response to the receiving the paging indication and the PEI.

In some embodiments, the method further comprises receiving, by the communication device, a paging early indication (PEI) that indicates whether the communication device is expected to receive a synchronization signal block (SSB) and a positioning reference signal. In some embodiments, the wireless device determines not to detect or receive or monitor the SSB and/or the positioning reference signal in response to an absence of reception of the paging indication. In some embodiments, the method further comprises receiving, by the wireless device, a control information or a paging related signaling that indicates to the communication to enter a sleep mode after: a paging occasion, receiving a positioning reference signal, the paging occasion and the receiving the positioning reference signal, a time duration after the paging occasion and the receiving the positioning reference signal, a time duration after a reception of a paging early indication (PEI), or transmission of a measurement report or a small data transmission.

In some embodiments, the paging indication is associated with one paging reception window, one periodic paging time window (PTW), one paging occasion (PO), one paging frame (PF), one or more PO sub-groups, one or more PF sub-groups, one paging monitoring occasion (PMO), or one or more PMO sub-groups, where at least one of the one or more PO sub-groups includes one or more POs, at least one of the one or more PF sub-groups includes one or more PFs, or at least one of the one or more PMO sub-groups includes one or more PMOs. In some embodiments, the wireless device includes a base station, and where the method further comprises: receiving, by the base station, a reference signal received power (RSRP) related information from a location management function (LMF) that includes any one or more of the following: a RSRP value, a positioning reference signal (PRS) resource and/or resource set configuration that includes a PRS time configuration or PRS frequency configuration, and/or a center frequency, a time stamp, a reference signal time difference (RSTD) or a UE receive-transmit timing value, a physical cell identifier, a cell global identifier, a downlink physical reference signal resource identifier.

In some embodiments, the RSRP related information is reported by a communication device to the LMF. In some embodiments, the wireless device includes a communication device, where the determining the paging indication includes receiving the paging indication, and where the performing the positioning related operation includes receiving a positioning reference signal. In some embodiments, the wireless device includes a base station, where the determining the paging indication includes transmitting the paging indication, and where the performing the positioning related operation includes receiving a sounding reference signal.

In some embodiments, a communication device (e.g., a UE) can be configured to receive a reference signal in a time window by receiving, in response to the receiving the paging indication, the reference signal in the time window.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
determining, by a wireless device, a paging indication; and
performing a positioning related operation in response to the determining the paging indication, wherein the positioning related operation is associated with the paging indication.

2. The method of claim 1,
wherein an association between the positioning related operation and the paging indication is included in a system information block (SIB) or a radio resource control (RRC) release signaling received by the communication device.

3. The method of claim 1,
wherein the positioning related operation is performed by the wireless device in an inactive state or an idle state, and
wherein the positioning related operation includes receiving or transmitting a reference signal, transmitting a measurement report, receiving a first shared channel, or transmitting a second shared channel.

4. The method of claim 3, wherein the receiving or transmitting the reference signal includes receiving a positioning reference signal or transmitting a sounding reference signal.

5. The method of claim 1, further comprising:
receiving, by the wireless device, the paging indication in a periodic paging time window (PTW),
wherein the wireless device performs the positioning related operation in the PTW in response to receiving the paging indication.

6. The method of claim 1, further comprising:
receiving, by the wireless device, a paging early indication (PEI) that indicates that the wireless device is expected to receive the paging indication,
wherein the wireless device performs the positioning related operation in response to the receiving the paging indication and the PEI.

7. The method of claim 6,
wherein the wireless device receives a system information block (SIB) or a radio resource control (RRC) release signaling that indicate:
(1) whether the PEI indicates that the wireless device is expected to receive the paging indication, or
(2) whether one or more time windows for performing the positioning related operation is associated with the paging indication that is indicated by the PEI.

8. The method of claim 7, further comprising:
receiving, by the wireless device, a paging early indication (PEI) that indicates that the wireless device is expected to receive the paging indication,
wherein the wireless device performs the positioning related operation in response to the receiving the paging indication and the PEI and response to one or more conditions between the one or more time windows for performing the positioning related operation and the paging indication being satisfied.

9. The method of claim 8, wherein the one or more conditions is satisfied when the paging indication is received overlapping with a time window in time domain.

10. The method of claim 8, wherein the one or more conditions is satisfied in response to a distance in time domain between the paging indication and a time window being less than a threshold.

11. The method of claim 1, further comprising:
receiving, by the wireless device, a paging early indication (PEI) that indicates that the wireless device is expected to receive the paging indication,
wherein the paging indication indicates that a time window is valid, and
wherein the wireless device receives a positioning reference signal in response to the receiving the paging indication and the PEI.

12. The method of claim 7, further comprising:
receiving, by the communication device, a paging early indication (PEI) that indicates whether the communication device is expected to receive a synchronization signal block (SSB) and a positioning reference signal.

13. The method of claim 12, wherein the wireless device determines not to detect or receive or monitor the SSB and/or the positioning reference signal in response to an absence of reception of the paging indication.

14. The method of claim 1, further comprising:
receiving, by the wireless device, a control information or a paging related signaling that indicates to the communication to enter a sleep mode after:
a paging occasion,
receiving a positioning reference signal,
the paging occasion and the receiving the positioning reference signal,
a time duration after the paging occasion and the receiving the positioning reference signal,
a time duration after a reception of a paging early indication (PEI), or
transmission of a measurement report or a small data transmission.

15. The method of claim 1,
wherein the paging indication is associated with one paging reception window, one periodic paging time window (PTW), one paging occasion (PO), one paging frame (PF), one or more PO sub-groups, one or more PF sub-groups, one paging monitoring occasion (PMO), or one or more PMO sub-groups,
wherein at least one of the one or more PO sub-groups includes one or more POs, at least one of the one or more PF sub-groups includes one or more PFs, or at least one of the one or more PMO sub-groups includes one or more PMOs.

16. The method of claim 1, wherein the wireless device includes a base station, and wherein the method further comprises:
receiving, by the base station, a reference signal received power (RSRP) related information from a location management function (LMF) that includes any one or more of the following:
a RSRP value,
a positioning reference signal (PRS) resource and/or resource set configuration that includes a PRS time configuration or PRS frequency configuration, and/or a center frequency,
a time stamp,
a reference signal time difference (RSTD) or a UE receive-transmit timing value,
a physical cell identifier,
a cell global identifier,
a downlink physical reference signal resource identifier.

17. (canceled)

18. The method of claim 1, wherein the wireless device includes a communication device, wherein the determining the paging indication includes receiving the paging indication, and wherein the performing the positioning related operation includes receiving a positioning reference signal.

19. The method of claim 1, wherein the wireless device includes a base station, wherein the determining the paging indication includes transmitting the paging indication, and wherein the performing the positioning related operation includes receiving a sounding reference signal.

20. An apparatus for wireless communication comprising a processor, configured to implement a method of claim 1.

21. A non-transitory computer readable program storage medium having code stored thereon, the code, when executed by a processor, causing the processor to implement a method of claim 1.
